(19) United States
(12) Patent Application Publication
(10) Pub. No.: US 2021/0357935 A1
(43) Pub. Date: Nov. 18, 2021

(54) SYSTEMS AND METHODS FOR INTEGRATED PAYMENT TERMINAL PAYMENTS

(71) Applicant: VeriFone, Inc., San Jose, CA (US)

(72) Inventors: Timothy O'LOUGHLIN, Fort Lauderdale, FL (US); Tony LUCENTO, Alpharetta, GA (US); Clinton CAREY, Alpharetta, GA (US)

(21) Appl. No.: 16/877,224

(22) Filed: May 18, 2020

(51) Int. Cl. G06Q 20/40; G06Q 20/32; G06Q 20/36; G06Q 20/38

(52) U.S. Cl. CPC G06Q 20/401; G06Q 20/3278; G06Q 20/38215; G06Q 20/3276; G06Q 20/3674

(57) ABSTRACT

A method for integrated payment terminal payments may include: (1) receiving, at a first payment terminal, encrypted card information for a transaction from a second payment terminal, the first payment terminal and the second payment terminal in communication with each other; and (2) communicating, to a payment processor, the encrypted card information, transaction information, and a unique identifier for the second payment terminal to a payment processor, wherein the unique identifier for the second payment terminal is different from a unique identifier for the first payment terminal.

### BACKGROUND OF THE INVENTION

### 1. Field of the Invention

The present disclosure relates generally to systems and methods for integrated payment terminal payments.

### 2. Description of the Related Art

In order for a payment terminal, such as a credit card reader, to be deployed, it must undergo a rigorous certification process. The certification process ensures that the payment terminal complies with standards promulgated by, for example, Europay, Mastercard, and Visa (EMV) and the Payment Card Industry (PCI). Thus, bringing a new payment terminal to the market is both time consuming and costly.

### SUMMARY OF THE INVENTION

Systems and methods for integrated payment terminal payments are disclosed. In one embodiment, a method for integrated payment terminal payments may include: (1) receiving, at a first payment terminal, encrypted card information for a transaction from a second payment terminal, the first payment terminal and the second payment terminal in communication with each other; and (2) communicating, to a payment processor, the encrypted card information, transaction information, and a unique identifier for the second terminal to a payment processor, wherein the unique identifier for the second terminal is different from a unique identifier for the first payment terminal.

In one embodiment, further comprising receiving, at the first payment terminal, the unique identifier for the second payment terminal. The unique identifier for the second payment terminal may be received before the encrypted card information is received, may be received concurrently with the encrypted card information, etc.

In one embodiment, the method may further include receiving, at the first payment terminal, authorization for the transaction; and communicating the authorization for the transaction to the second payment terminal.

In one embodiment, the second payment terminal may receive the card information and encrypts the card information.

In one embodiment, the card information may be received by near-field communication.

According to another embodiment, a system for conducing integrated payment terminal payments may include: a first payment terminal comprising a first card/device reader and having a first unique identifier, and a second payment terminal in communication with the first payment terminal and comprising a second card/device reader and having a second unique identifier, the second unique identifier being different from the first unique identifier. The second payment terminal may receive card information at the second card/device reader, and may encrypt the card information and communicate the encrypted card information to the first payment terminal. The first payment terminal may communicate the encrypted card information, transaction information, and the second unique identifier to a payment processor.

In one embodiment, the first payment terminal may receive the second unique identifier before receiving the encrypted card information, may receive the second unique identifier with the encrypted card information, etc.

In one embodiment, the first payment terminal may receive authorization for the transaction and communicates the authorization to the second payment terminal.

In one embodiment, the card information may be received by near-field communication.

In one embodiment, the card information may be received from a mobile electronic device.

According to another embodiment, a method for integrated payment terminal payments may include: (1) receiving, at a first payment terminal or a second payment terminal, the first payment terminal and the second payment terminal in communication with each other, an indication that a transaction will be conducted using an alternate payment mechanism from an alternate payment provider; (2) receiving, from the first payment terminal, a machine-readable code comprising transaction information for the transaction, a merchant identifier, and a unique identifier for the first payment terminal and the second payment terminal to be used with the alternate payment provider; (3) displaying, on a display for the second payment terminal, the machine-readable code; and (4) receiving, from the first payment terminal, authorization for the transaction, the authorization received by the first payment terminal from the alternate payment provider.

In one embodiment, the machine-readable code may include a bar code or a QR code.

In one embodiment, the unique identifier for the first payment terminal and the second payment terminal to be used with the alternate payment provider may be stored by the first payment terminal.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for integrated payment terminal payments according to one embodiment;

FIG. 2 depicts a method for integrated payment terminal payments according to one embodiment;

FIG. 3 depicts a method for integrated payment terminal payments according to another embodiment.

### DETAILED DESCRIPTION OF PREFERRED EMBODIMENTS

Embodiments are directed to systems and methods for integrated payment terminal payments.

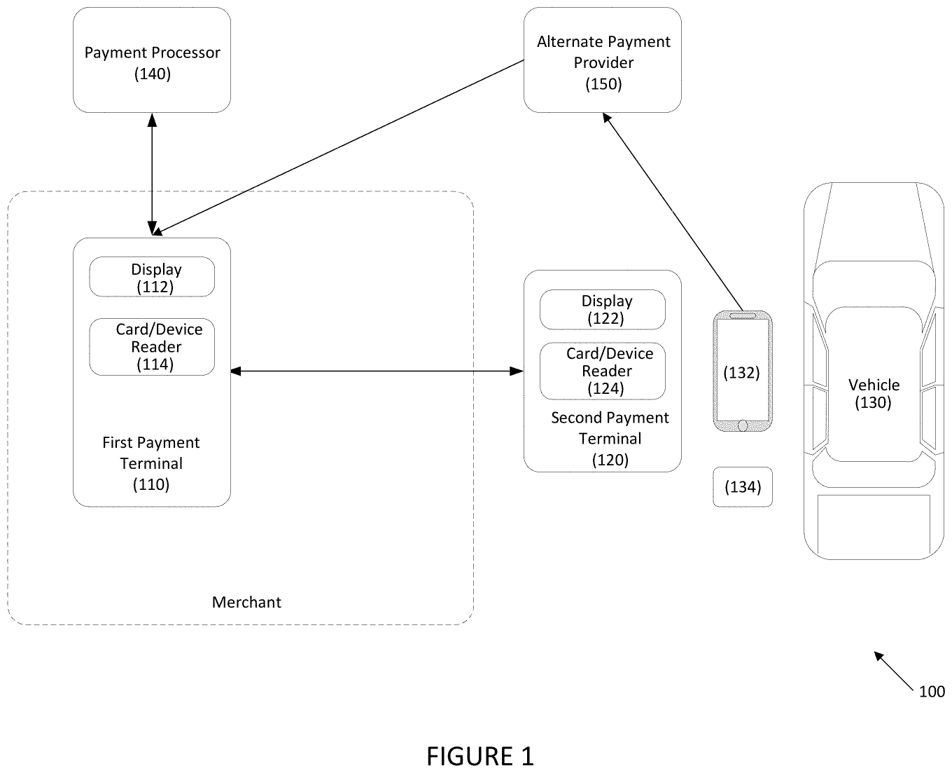

Referring to FIG. 1, a block diagram of a system for integrated payment terminal payments is disclosed according to one embodiment. System 100 may include first payment terminal 110 and second payment terminal 120 at a merchant facility. In one embodiment, first payment terminal 110 may be located on the inside of the merchant facility, and second payment terminal 120 may be located outside of the merchant facility. For example, second payment terminal 120 may be positioned to receive payment from vehicle 130 at a drive-thru lane for the merchant.

First payment terminal 110 may include display 112, card/device reader 114 (e.g., magnetic stripe reader, EMV chip reader, contactless (e.g., near-field communication (NFC) reader, bar code reader, etc.), etc. First payment terminal 110 may also include one or more computer processors (not shown), a memory (not shown), etc.

Second payment terminal 120 may include display 122, card/device reader 124 (e.g., magnetic stripe reader, EMV chip reader, contactless (e.g., NFC) reader, bar code reader, etc.), etc. Second payment terminal 120 may also include one or more computer processors (not shown), a memory (not shown), etc.

First payment terminal 110 may communicate with payment processor 140. Payment processor 140 may communicate with an issuer (not shown) to authorize a payment.

First payment terminal 110 and second payment terminal 120 may receive card information from contactless credit card 134, mobile wallet executed by a mobile electronic device 132, etc.

Display 112 and display 122 may be coordinated and may display similar information. In one embodiment, the information displayed on display 112 may be customized for a merchant employee, and the information displayed on display 122 may be customized for the customer.

First payment terminal 110 and second payment terminal 120 may communicate by any suitable mechanism, such as wired communication, wireless communication, etc.

First payment terminal 110 and second payment terminal 120 may each be assigned a unique terminal identifier. First payment terminal 110 may be configured to conduct a transaction where payment is received by first payment terminal 110 or by second payment terminal 120 with payment processor 140. In order to conduct the transaction where payment is received at second payment terminal 120, first payment terminal 110 includes the unique identifier for second payment terminal 120 when communicating with payment processor 140. First payment terminal 110 may learn second payment terminal 120's unique identifier during installation, registration, etc.

Second payment terminal 120 may not be able to independently conduct a transaction with payment processor 140.

Mobile electronic device 132 may communicate with alternate payment provider 150, such as PayPal, Venmo, Alipay, etc. For example, a camera (not shown) on mobile electronic device 132 may capture an image of a machine-readable code (e.g., barcode, QR code, etc.) and, using a mobile computer application, may provide transaction details, including merchant identification, a unique identifier for first payment terminal 110 and second payment terminal 120 for use with alternate payment provider 150, a payment amount, etc., in the machine-readable code, and customer account information with alternate payment provider 150, to alternate payment provider 150. The unique identifier for first payment terminal 110 and second payment terminal 120 for use with alternate payment provider 150 may be stored on first payment terminal 110.

Alternate payment provider 150 may decision the transaction, and return the decision to first payment terminal 110 to that first payment terminal 110 may finalize the transaction and respond the disposition. First payment terminal 110 may issue a command to second payment terminal 120 to present a message to the customer, such as “Thank You” or “Enjoy Your Meal”.

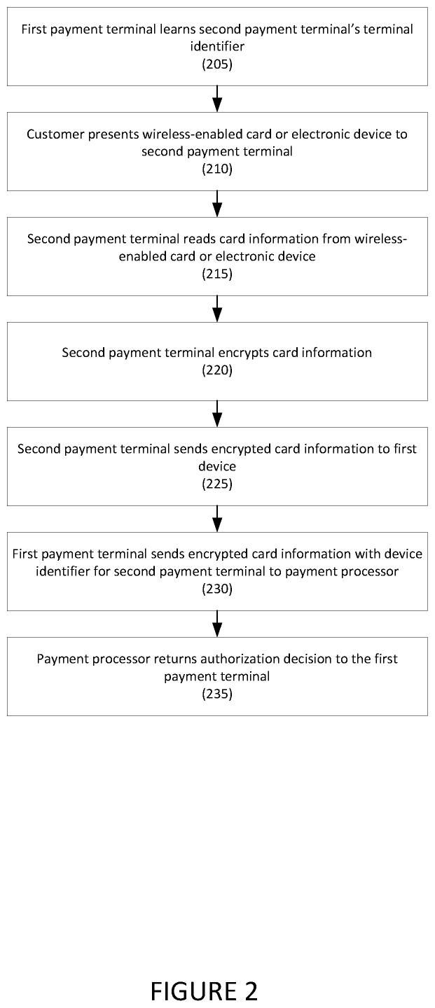

Referring to FIG. 2, a method for integrated payment terminal payments is disclosed according to one embodiment.

In step 205, in an optional step, a first payment terminal may learn a second payment terminal's unique identifier. In one embodiment, the first payment terminal may be configured to conduct a transaction in which card information (e.g., from a credit card, mobile wallet executed by an electronic device, etc.) is received by the second payment terminal.

In step 210, a customer may conduct a transaction and may present card information at the second payment terminal. For example, the customer may present a credit card (e.g., swipe, dip, tap, etc.), or a mobile wallet application to the second payment terminal.

In step 215, the second payment terminal may read the card information from the card or mobile wallet application.

In step 220, the second payment terminal may encrypt some or all of the card information and, in step 225, may send the encrypted card information to the first payment terminal. In one embodiment, the second terminal may include its unique identifier. For example, the second terminal may include its unique identifier if the first terminal does not have it, to confirm the identity of the second terminal, etc.

In step 230, the first terminal may send the encrypted card information with the unique identifier for the second payment terminal.

In step 235, the payment processor returns an authorization decision to the first payment terminal, and the first payment terminal may provide the authorization decision to the second payment terminal.

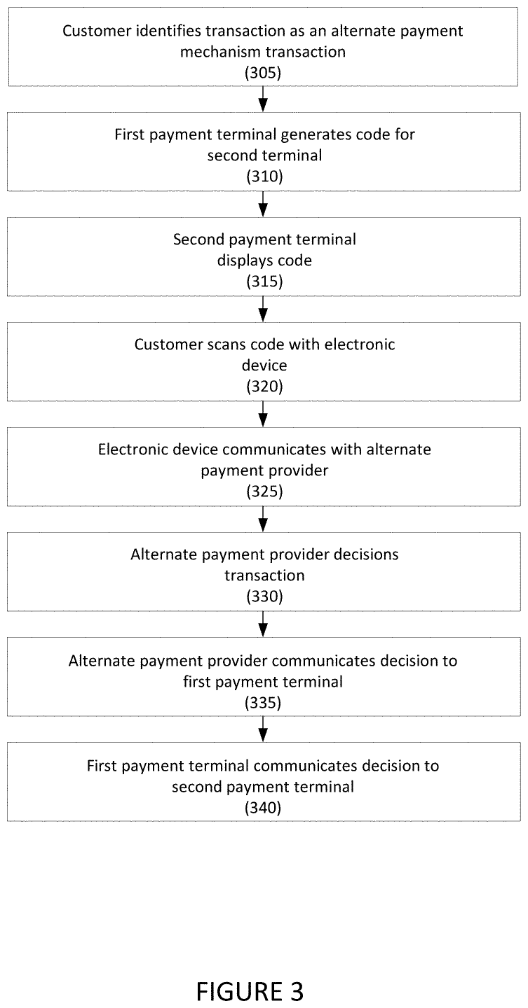

Referring to FIG. 3, a method for integrated payment terminal payments is disclosed according to another embodiment.

In step 305, a customer may identify a transaction as an alternate payment mechanism transaction with an alternate payment provider. Examples include PayPal, Venmo, Alipay, etc.

In one embodiment, the customer may tell the merchant's employee that the transaction is an alternate payment mechanism transaction. In another embodiment, the customer may indicate that the payment is an alternate payment mechanism transaction on the second payment terminal's interface (e.g., screen, keypad, etc.).

In step 310, the first payment terminal may generate a machine-readable code for the transaction and may communicate the machine-readable code (e.g., a bar code, QR code, etc.) to the second payment terminal. The machine-readable code may include a merchant identifier, a unique identifier for the first and second payment terminal that is specific to the alternate payment provider, and transaction details.

In step 315, the second payment terminal may display the machine-readable code, and in step 320, the customer may scan the machine-readable code using, for example, the camera on a mobile electronic device.

In step 325, the mobile electronic device, or a computer application executed thereon, may communicate the contents of the machine-readable code (e.g., merchant identifier, unique identifier for the first payment terminal, transaction information) to the alternate payment provider.

In step 330, the alternate payment provider may decision the transaction, and in step 335, may communicate the decision to the first payment terminal.

In step 340, the first payment terminal may communicate the decision to the second payment terminal.

It will be appreciated by persons skilled in the art that the present invention is not limited by what has been particularly shown and described hereinabove. Rather, the scope of the present invention includes both combinations and sub-combinations of features described hereinabove and variations and modifications thereof, which are not in the prior art. It should further be recognized that these embodiments are not exclusive to each other.

It will be readily understood by those persons skilled in the art that the embodiments disclosed herein, are susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1-19. (canceled)

20. A method for integrated merchant payment terminal payments, comprising:
receiving, by a computer processor of a first payment terminal, payment data for a payment transaction from a second payment terminal, wherein the first payment terminal is certified to process payments with a payment processor based on a payment terminal processing standard, and the first payment terminal is configured to process, with the payment processor, payments received at the first payment terminal and payments received from the second payment terminal, wherein the second payment terminal is unable to process payments directly with the payment processor;
determining, by the computer processor of the first payment terminal, a unique identifier identifying the second payment terminal;
transmitting, by the computer processor of the first payment terminal, the payment data with the unique identifier identifying the second payment terminal to a computer associated with the payment processor;
receiving, by the computer processor of the first payment terminal, a payment approval or a payment rejection of the payment transaction from the payment processor in response to the transmitting; and
communicating, by the computer processor of the first payment terminal, the payment approval or the payment rejection for the payment transaction to the second payment terminal so as to enable the second payment terminal to accept payment for the payment transaction.

21. The method of claim 20, wherein the payment data comprises encrypted payment card information.

22. The method of claim 20, wherein the unique identifier identifying the second payment terminal is determined before the payment data for the payment transaction is received from a second payment terminal.

23. The method of claim 20, wherein the unique identifier identifying the second payment terminal is determined concurrently with the payment data for the payment transaction being received from a second payment terminal.

24. The method of claim 20, wherein the payment data is received by the second payment terminal by near field communication.

25. The method of claim 20, wherein the first payment terminal and the second payment terminal are in wired communication with each other.

26. The method of claim 20, wherein the first payment terminal is associated with a unique identifier identifying the first payment terminal, wherein the unique identifier identifying the second payment terminal and the unique identifier identifying the first payment terminal are different.

27. A system for integrated merchant payment terminal payments, comprising:
a first payment terminal comprising a computer processor, wherein the first payment terminal is certified to process payments with a payment processor based on a payment terminal processing standard;
a second payment terminal in communication with the first payment terminal and comprising a computer, wherein the second payment terminal is unable to process payments directly with the payment processor;
the first payment terminal is configured to process, with the payment processor, payments received at the first payment terminal and payments received from the second payment terminal;
the computer processor of the first payment terminal is configured to receive payment data for a payment transaction from the second payment terminal;
the computer processor of the first payment terminal is configured to determine a unique identifier identifying the second payment terminal;
the computer processor of the first payment terminal is configured to transmit the payment data with the unique identifier identifying the second payment terminal to a computer associated with the payment processor;
the computer processor of the first payment terminal is configured to receive a payment approval or a payment rejection of the payment transaction from the payment processor in response to the transmitting; and
the computer processor of the first payment terminal the payment is configured to communicate the payment approval or the payment rejection for the payment transaction to the second payment terminal so as to enable the second payment terminal to accept payment for the payment transaction.

28. The system of claim 27, wherein the payment data comprises encrypted payment card information.

29. The system of claim 27, wherein the unique identifier identifying the second payment terminal is determined before the payment data for the payment transaction is received from a second payment terminal.

30. The system of claim 27, wherein the unique identifier identifying the second payment terminal is determined concurrently with the payment data for the payment transaction being received from a second payment terminal.

31. The system of claim 27, wherein the payment data is received by the second payment terminal by near field communication.

32. The system of claim 27, wherein payment data is received by the second payment terminal from a mobile electronic device.

33. The system of claim 27, wherein the first payment terminal and the second payment terminal are in wired communication with each other.

34. The system of claim 28, wherein the first payment terminal is associated with a unique identifier identifying the first payment terminal, wherein the unique identifier identifying the second payment terminal and the unique identifier identifying the first payment terminal are different.

35. A method for integrated merchant payment terminal payments with alternate payment mechanism providers, comprising:
receiving, by a computer processor of a first payment terminal, an indication that a payment transaction with a second payment terminal will be conducted with an alternate payment mechanism provider, wherein the first payment terminal is in communication with the alternate payment mechanism provider, and the second payment terminal is unable to communicate directly with the alternate payment mechanism provider;
generating, by the computer processor for the first payment terminal, a machine-readable code for the alternate payment mechanism provider, wherein the machine-readable code comprises transaction information for the payment transaction, a merchant identifier, a unique identifier for the first payment terminal that is specific to the alternate payment mechanism provider, and a unique identifier for the second payment terminal that is specific to the alternate payment mechanism provider;
communicating, by the computer processor for the first payment terminal, the machine-readable code to a computer processor for the second payment terminal;
displaying, by the computer processor for the second payment terminal and on a display for the second payment terminal, the machine-readable code;
receiving, at the computer processor for the first payment terminal and from the alternate payment mechanism provider, authorization for the payment transaction; and
instructing, by the computer processor for the first payment terminal, the computer processor for the second payment terminal to display the authorization for the payment transaction on the display for the second payment terminal.

36. The method of claim 35, wherein the machine-readable code comprises a bar code or a QR code.

37. The method of claim 35, wherein the unique identifier for the first payment terminal and the unique identifier for the second payment terminal are stored by the first merchant payment terminal.
